(19) United States
(12) Patent Application Publication
(10) Pub. No.: US 2015/0105026 A1
(43) Pub. Date: Apr. 16, 2015

(54) METHOD FOR SHOWING AN INSTANT NOTICE ON A DISPLAY OF COMPUTER ACCORDING TO AN INCOMING EVENT OF A MOBILE DEVICE

(71) Applicant: Gary Kung, Taipei City (TW)

(72) Inventor: Gary Kung, Taipei City (TW)

(73) Assignee: I/O INTERCONNECT INC., Taipei City (TW)

(21) Appl. No.: 14/580,162

(22) Filed: Dec. 22, 2014

Related U.S. Application Data
(63) Continuation-in-part of application No. 13/241,708, filed on Sep. 23, 2011, now abandoned.

(51) Int. Cl. H04W 4/06; H04W 24/08

(52) U.S. Cl. CPC H04W 4/06; H04W 24/08
USPC 455/67.7

(57) ABSTRACT

A method for showing an instant notice on another device is disclosed. The method includes the steps of: a) installing a first application and a second application to a mobile device and a personal computer, respectively; b) operably connecting the mobile device to the computer; c) executing the first application to monitor if an incoming event occurs in the mobile device; d) the first application sending a message about the incoming event to the second application; and e) the second application showing a notice window on a display screen of the computer.

### CROSS-REFERENCE TO RELATED APPLICATIONS

This application is a continuation-in-part of U.S. patent application Ser. No. 13/241,708 filed Sep. 23, 2011, previously abandoned, now reviving.

### BACKGROUND OF THE INVENTION

1. Technical Field

The invention relates to notice of incoming events of mobile devices, particularly to synchronized notice of incoming events from a mobile device to a personal computer.

2. Related Art

In recent years, mobile devices such as smartphones or tablets have become a must-have article almost for everyone. When in an office or home, some users prefer using a desktop or laptop computer for work, game playing or internet surfing rather than to use a mobile device because of much larger display screen and easy operation. Under this situation, users tend to carelessly pretermit incoming events of their mobile devices, such as an SMS (Short Message Service) message, an IM (Instant Messaging) message or a phone call because the mobile devices are set into a silent mode or put on a remote place from the users. It is very possible that a user cannot timely reply to his or her incoming events. There is no solution hitherto.

### SUMMARY OF THE INVENTION

An object of the invention is to provide a method for showing an instant notice on a display of computer according to an incoming event of a mobile device, which can instantly show a notice window on a display of a personal computer when a mobile device receives an incoming event.

To accomplish the above object, the method of the invention includes the steps of: a) installing a first application and a second application to a mobile device and a personal computer, respectively; b) operably connecting the mobile device to the computer; c) executing the first application to monitor if an incoming event occurs in the mobile device; d) the first application sending a message about the incoming event to the second application; and e) the second application showing a notice window on a display screen of the computer.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

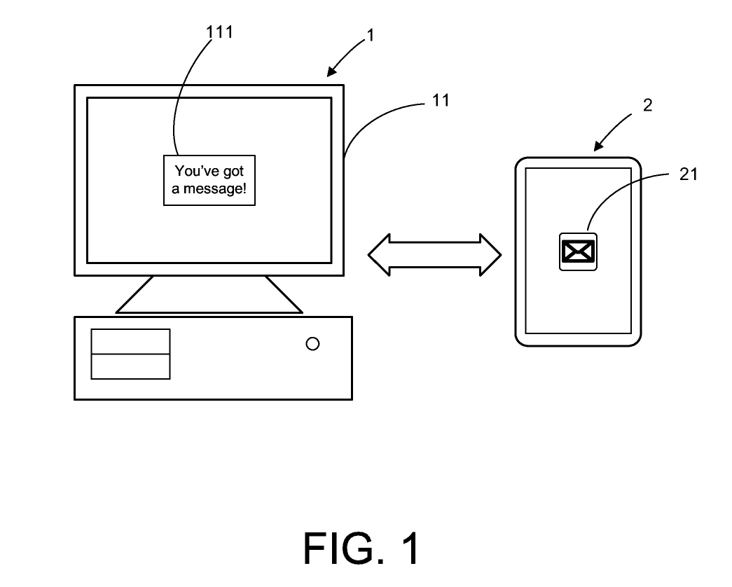

Please refer to FIG. 1. The invention provides a solution for showing an instant notice on a display of a personal computer 1 according to an incoming event of a mobile device 2. The personal computer 1 may be a desktop or laptop computer. The mobile device 2 may be a smartphone or a tablet computer. The mobile device 2 is operably connected to the personal computer 1. The connection between the mobile device 2 and the personal computer 1 is not a screencast. In other words, the personal computer 1 can still work independently and the picture shown on a display 11 of the personal computer 1 is different from that of the mobile device 2. The personal computer 1 can instantly show a notice window 111 on the display 11 of the personal computer 1 when the mobile device 2 receives an incoming event such as an SMS (Short Message Service) message, an IM (Instant Messaging) message or a phone call. Of course, a notice icon 21 will be also shown on the mobile device 2 when an incoming event is received by the mobile device 2.

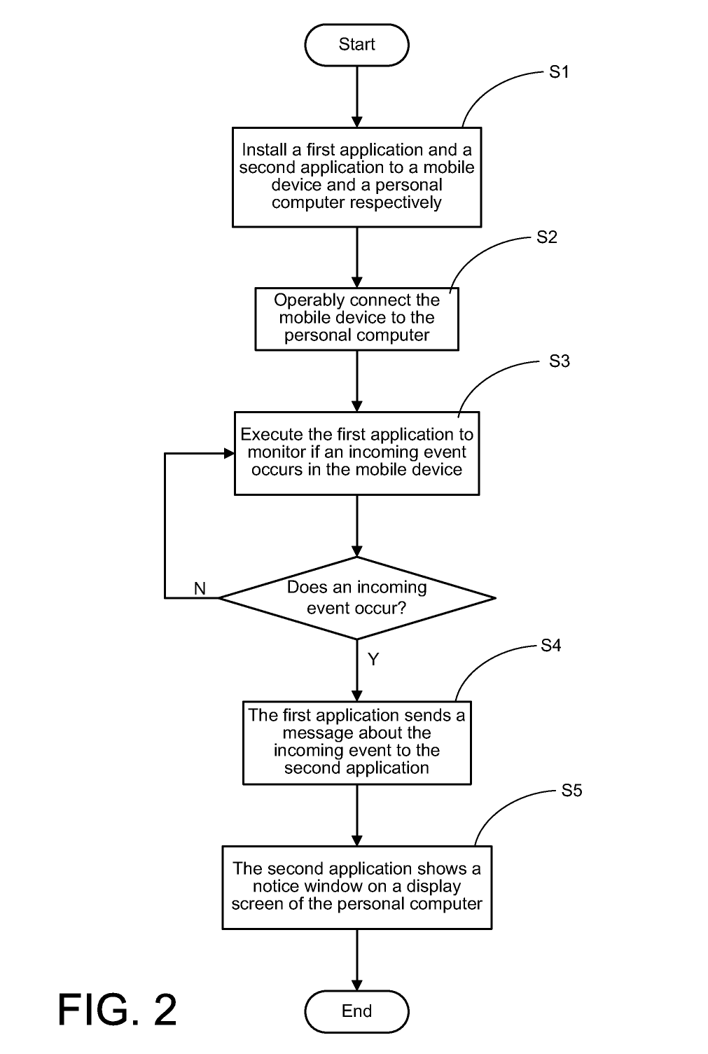

Please refer to FIG. 2, which shows a flowchart of the method of the invention. In step S1, a first application and a second application are installed to the mobile device 2 and a personal computer 1, respectively. The applications are software. In step S2, the mobile device 2 is operably connected to the personal computer 1. The connection between the mobile device 2 and the personal computer 1 may be wireless or wired. The wireless connection may follow the Wi-Fi® or BLUETOOTH standard. The USB (universal serial bus) standard may be used to serve as the wired connection when the mobile device 2 uses the ANDROID operating system and is set into the Debugging Mode (also known as Developer Mode). The USB Debugging Mode can establish a direct connection between an Android Device and a computer and readies it for deeper-level actions. Although general end users do not know how to change into the Debugging Mode, it is still available for advanced users or it will be possibly available for all users in the future. In step S3, the first application is executed to monitor if an incoming event occurs in the mobile device 2. For example, the incoming event may be an SMS message, an IM message or a phone call. In step S4, the first application sends a message about the incoming event to the second application when an incoming event occurs. Finally, in step S5 the second application shows a notice window 111 on the display screen 11 of the personal computer 1.

By the invention, the display 11 of the personal computer 1 can instantly show a notice window 111 when the mobile device 2 connected thereto receives an incoming event. Users will never pretermit any incoming events of their mobile devices even if they have been set into a silent mode.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for showing an instant notice, comprising:
a) installing a first application and a second application to a mobile device and a personal computer, respectively;
b) operably connecting the mobile device to the computer;
c) executing the first application to monitor if an incoming event occurs in the mobile device;
d) the first application sending a message about the incoming event to the second application; and
e) the second application showing a notice window on a display screen of the computer.

2. The method of claim 1, wherein the mobile device is a smartphone or a tablet computer.

3. The method of claim 1, wherein the personal computer is of a desktop or a laptop type.

4. The method of claim 1, wherein the step b) is performed wirelessly.

5. The method of claim 4, wherein a wireless connection in the step b) follows a Wi-Fi® standard.

6. The method of claim 4, wherein a wireless connection in the step b) follows a BLUETOOTH standard.

7. The method of claim 1, wherein the step b) is performed wiredly.

8. The method of claim 7, wherein a wired connection in the step b) follows a USB (universal serial bus) standard.

9. The method of claim 1, wherein the incoming event is an SMS (Short Message Service) message.

10. The method of claim 1, wherein the incoming event is an IM (Instant Messaging) message.

11. The method of claim 1, wherein the incoming event is a phone call.
